(19) United States
(12) Patent Application Publication
(10) Pub. No.: US 2002/0109491 A1
(43) Pub. Date: Aug. 15, 2002

(54) Regulated voltage generator for integrated circuit

(75) Inventor: Edith Kussener, Aix-En-Provence (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.A., Montrouge (FR)

(21) Appl. No.: 09/953,071

(22) Filed: Sep. 14, 2001

(30) Foreign Application Priority Data
Sep. 15, 2000 (FR) 0011800

(51) Int. Cl. G05F 3/16

(52) U.S. Cl. 323/313

(57) ABSTRACT

A regulated voltage generator provides different regulated voltages to an integrated circuit. The regulated voltage generator includes a bandgap reference circuit and at least one gain stage connected to an output thereof. The output voltage of the bandgap reference circuit varies as a function of temperature to compensate for variations in the gain stage made up of first and second transistors. A regulated voltage output by the regulated voltage generator is independent of temperature and of the supply voltage. The value of the regulated voltage is adjusted via a load resistor and via the first and second transistors along with an output transistor of the bandgap reference circuit.

### FIELD OF THE INVENTION

The present invention relates to integrated circuits, and more particularly, to voltage generators which provide different reference voltages required for supplying integrated circuits.

### BACKGROUND OF THE INVENTION

External power supplies for integrated circuits now vary between three volts and ten volts, whereas the voltages required by the internal power supplies for the electrical circuits within the integrated circuits are, depending on the application, 2.5 volts, 3 volts, 5 volts and 7 volts. These voltages are within ± 10%. It is therefore imperative that an integrated circuit itself generate these different voltages in order that they be independent of the power supply voltage and of temperature. For instance, the temperature may vary between −40° C. and 125° C.

To this end, there has been proposed a regulated voltage generator which exploits the properties of a reference voltage given by a circuit described in an article by E. Vittoz and J. Fellrath, entitled “CMOS Analog Integrated Circuits Based on Weak Inversion Operation”, published in IEEE Journal of Solid State Circuits, Vol. SC-12, no. 3, 1997, pages 224-231. This voltage reference circuit is generally known as a bandgap voltage reference circuit.

This prior art circuit supplies a reference voltage of 1.28 volts, known as the bandgap voltage, which is constant over a wide range of supply voltages and temperatures. To obtain the different required voltages, the circuit's output voltage is applied to gain stages, which each gain stage producing one of the required voltages.

However, these gain stages are sensitive to the supply voltage and to temperature, and the same holds for the power stage that follows them for supplying the required power. As a result, the voltages supplied vary significantly as a function of power supply voltage and of the temperature.

### SUMMARY OF THE INVENTION

An object of the present invention is to provide a generator for at least one regulated voltage that is not very sensitive to variations over a wide range of power supply voltages and temperatures.

This object is achieved by using a potential barrier reference voltage circuit, known as a bandgap type of circuit, and at least one gain stage. To provide a regulated voltage generator that is not sensitive to variations in the power supply voltage and temperature, the characteristics of the reference voltage are degraded to compensate for the variations due to the gain stage. The reference voltage then delivers a voltage which is a function of temperature variations opposite to that of the gain stage.

Another object of the present invention is to provide a generator producing a plurality of regulated voltages by implementing several gain stages.

The invention thus relates to a regulated voltage generator for supplying at least one regulated voltage to an integrated circuit comprising a bandgap type of reference voltage circuit and at least one gain stage. The bandgap type of reference voltage circuit comprises a current generator which supplies a bipolar transistor configured as a diode via a load resistor connected to the emitter of the bipolar transistor.

The gain stage comprises two MOS transistors in series between the supply voltage and a ground potential. The gate of a first transistor is connected to the gate of the output transistor of the current generator, and the gate of the second transistor is connected to the output of the bandgap type reference voltage circuit.

The characteristics of the first and second transistors are chosen to obtain the regulated voltage. The value of the load resistor is chosen such that the emitter-base voltage of the bipolar transistor varies with temperature in a manner to compensate for the variation of the gate-source voltage of the second transistor as a function of temperature.

### BRIEF DESCRIPTION OF THE DRAWINGS

Other characteristics and advantages of the present invention shall become more apparent from reading the following description of the preferred embodiments, given with reference to the appended drawings in which:

FIG. 1 is a schematic circuit diagram of a regulated voltage generator in accordance with the present invention; and

FIG. 2 is a block diagram of a device which delivers a regulated voltage among several available voltages in accordance with the present invention.

### DETAILED DESCRIPTION OF THE PREFERRED EMBODIMENTS

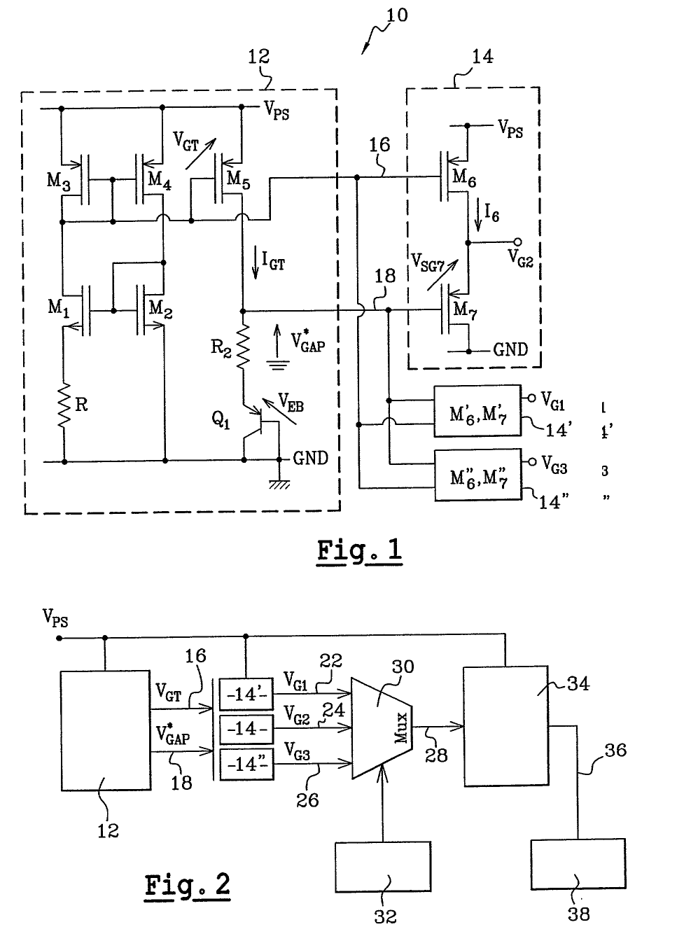

The regulated voltage generator 10 in accordance with the invention comprises (FIG. 1) a bandgap (potential barrier) reference voltage circuit 12 and at least one gain stage 14. The circuit 12 comprises four transistors M1, M2, M3 and M4 which are connected in a closed loop.

Transistors M1 and M2 are N-type MOS transistors whose sources are connected to a terminal at ground potential GND, either directly for transistor M2, or via a resistor R for transistor M1. The gates of transistors M1 and M2 are connected to one another and to the drain of transistor M2, which is connected to the drain of MOS transistor M4. Transistor M4 is a P-type transistor, and its source is connected to the supply voltage V_{PS}. The gate of transistor M4 is connected to the gate and to the drain of MOS transistor M3, which is a P-type transistor, and is connected to the drain of transistor M1. The source of transistor M3 is connected to the supply voltage V_{PS}.

The gates of transistors M3 and M4 are connected to the gate of a P-type MOS transistor M5 whose source is connected to the supply voltage V_{PS}. The drain of transistor M5 is connected to the ground potential GND via a resistor R₂, and a PNP type bipolar transistor Q1 is connected as a diode. Bipolar transistor Q1 has its emitter connected to a terminal of resistor R₂ while its other two electrodes are connected to the ground potential GND so that it functions as a diode.

The bandgap type reference voltage circuit 12 has two output terminals 16 and 18. One output terminal 16 corresponds to the common node of the gates of transistors M3, M4 and MS, and the other output terminal 18 corresponds to the drain of transistor M5.

The gain stage 14 comprises two P-type MOS transistors M6 and M7. The gate of transistor M6 is connected to output terminal 16, while the gate of transistor M7 is connected to output terminal 18. The source of transistor M6 is connected to the supply voltage V_{PS}, while its drain is connected to the source of transistor M7. The drain of transistor M7 is connected to the ground potential GND. The regulated output voltage V_{G2} is taken from the terminals of transistor M7, i.e., between the ground potential GND and the source of transistor M7.

Transistors M1 to M5 and resistor R form a current source producing a current I_{GT}. This current is supplied by transistor M5, and flows through resistor R₂ and bipolar transistor Q1. Transistor Q1 is connected as a PN diode, and the current I_{GT} varies proportionally with temperature.

In a prior art bandgap type of reference voltage circuit, the value of R₂ is chosen to produce a voltage V_{GAP}≈1.28 volts at the terminals of Q1 and R₂, which is not sensitive to temperature. This voltage V_{GAP} is used in the gain stage 14 to obtain the required voltage V_{G2}, which is greater than V_{GAP}.

In this gain stage, since the output voltage V_{G2} is the sum of V_{GAP} and the voltage V_{SG7} between the gate and the source of transistor M7, with V_{SG7} varying with temperature, V_{G2} also varies with temperature.

The invention includes making V_{GAP} vary, so that it becomes V*_{GAP}, as a function of temperature in order to compensate for the variation of V_{SG7} as a function of temperature. This is obtained by adjusting the value of resistor R₂ and the sizes of transistors M5, M6 and M7.

To this end, a first equation defines the current I_{GT}:

I_{GT}(T)≈I_{GT}(T₀)×(T/T₀) (1)

with the temperature T being expressed as an absolute value, and the temperature T₀ being the reference temperature of 27° C.

A second equation defines the output voltage V_{G2} such that:

V_{G2}=V*_{GAP}+V_{SG7}≈V_{EB}+R₂I_{GT}+V_{T7}+η₂√I_{GT} (2)

where

V_{EB} is the emitter-base voltage of transistor Q1,

η₂ is a term which depends on the W/L `coefficients of transistors M5, M6 and M7,

V_{T7} is an intrinsic characteristic voltage of transistor M7, referred to as the threshold voltage, and

V*_{GAP} is the variable voltage which depends on the temperature at the terminals of resistor R₂ and of bipolar transistor Q₁. This is the output voltage of the bandgap reference voltage stage.

A third equation defines the variation of η₂ as a function of temperature:

η₂(T)≈η₂(T₀) (T₀/T)^{m} (3)

with m being in the region of two.

These three equations (1), (2) and (3) make it possible to determine the values of η₂ and R₂ by the following formulas:

η₂≈0.4[(V_{G2}−V_{EB}+V_{T7})−T₀(δV_{EB}/δT)]/[√I_{GT}(T₀)] (4a)

R₂=0.2[3(V_{G2}−V_{EB}+V_{T7})+2T₀(δV_{EB}/δT)]/[I_{GT}(T₀)] (4b)

with δV_{EB}/δT being in the region of 1.8 mV/° C.

These two formulas lead to values of R₂=550 kΩ and η₂=493 to obtain a value V_{G2}=2.94 volts, which varies by 300 μV/° C., that is 49.5 mV in the temperature range of −40° C. to +125° C. for V_{PS}=10 volts.

The voltage V*_{GAP} can be used to obtain other voltages V_{G1} and V_{G3} by applying that voltage to two gain stages 14′and 14″in which the transistors M′6, M′7 and M″6, M″7 are determined by the coefficients η₁ and η₃ calculated using formula (4a). Calculated values of η₂=493 for V_{G1}=2.46 volts and η₃=635 for V_{G3}=3.43 volts are provided, for example.

However, these voltages V_{G1} and V_{G3} are sensitive to temperature variations, on the order of a millivolt per degree Celsius. To obtain a voltage V_{G1} or V_{G3} that would not be sensitive to temperature, it would be necessary to modify R₂ according to formula (4b) to obtain R₁ for the case of voltage V_{G1}, and R₃ for the case of voltage VG₃.

Moreover, coefficient η₂ not only determines the characteristics of transistors M6 and M7, but also transistor of M5 according to the formula:

$${η}_{2} = \frac{{[ W6 \cdot L5 / W5 \cdot L6 ]}^{1 / 2}}{{[ μ7 \cdot Cox ( W7 / L7 ) ]}^{1 / 2}}$$

where:

W and L are respectively the width W and the length L of the drain-source channel of transistors M5 (W5 and L5), M6 (W6, L6) and M7 (W7, L7), μ7 is the mobility of transistor M7, and Cox is the oxide capacitance.

FIG. 2 is a functional block diagram of a device which supplies one of the three voltages V_{G1}, V_{G2} or V_{G3} on demand. This device comprises the bandgap type reference voltage circuit 12 of the diagram in FIG. 1, and supplies on output terminal 18 the voltage V*_{GAP} as well as the voltage V_{GT} of transistor M5 on output terminal 16. Output terminals 16 and 18 are connected to the input terminals of the gain stages 14′, 14 and 14″, which respectively supply the voltages V_{G1}, V_{G2} and V_{G3}.

Only the voltage V_{G2} which corresponds to the value R₂ calculated from formula (4b) is in fact regulated, and hence substantially independent of temperature variations. The output terminals of gain stages 14′, 14 and 14″ are each connected to one of three input terminals 22, 24, 26 of a multiplexing circuit 30 which produces the connection between one of the three input terminals 22, 24, 26 and its output terminal 28. Selection of the connection is obtained by a control circuit 32 using appropriate signals.

The output terminal 28 of the multiplexing circuit 30 is connected to the input terminal of a power amplifier 34, whose output terminal 36 is connected to an electronic circuit to be supplied, such as a microprocessor 38, for example.

That which is claimed is:

1. Regulated voltage generator for supplying at least one regulated voltage (V_{G1}, V_{G2}, V_{G3}) to an integrated circuit (38), comprising a bandgap type of reference voltage circuit (12) and at least one gain stage (14, 14′, 14″), said bandgap type of reference voltage circuit (12) comprising a current generator (M1 to M5, R) which supplies a bipolar transistor (Q₁) connected as a diode via a load resistor (R₂) connected to the emitter of the bipolar transistor (Q₁), characterized in that:
the gain stage (14, 14′, 14″) comprises two MOS transistors (M6, M7) in series between the supply voltage (V_{PS}) and the ground terminal (GND), the gate of a first transistor (M6) being connected to the gate of the output transistor (M5) of the current generator and the gate of the second transistor (M7) being connected to the output of the bandgap type reference voltage circuit, the characteristics of said transistors (M6, M7) being chosen to obtain the regulated voltage (V_{G1}, V_{G2}, V_{G3}), and
the value of the load resistor (R₂) is chosen such that the emitter-base voltage (V_{EB}) of the bipolar transistor (Q1) varies with temperature in a manner to compensate the variation of the gate-source voltage (V_{SG7}) of the second transistor (M7) as a function of temperature.

2. Generator according to claim 1, characterized in that the characteristics of the two transistors (M6, M7) of the gain stage are defined by the formula:
η₂≈0.4[(V_{G2}−V_{EB}+V_{T7})−T₀(δV_{EB}/δT)]/[√I_{GT}(T₀)] (4a)
in which formula:
V_{G2} is the value of the regulated voltage to be obtained,
V_{EB} is the emitter-base voltage of the bipolar transistor (Q₁),
V_{T7} is the threshold voltage of transistor M7,
T₀ is the reference temperature,
I_{GT} is the current supplied by the current generator, and
δV_{EB}/δT is the variation of the voltage V_{EB} as a function of temperature T.

3. Generator according to claim 1 or 2, characterized in that the load resistor (R₂) is defined by the formula:
R₂=0.2[3(V_{G2}−V_{EB}+V_{T7})+2T₀(δV_{EB}/δT)]/[I_{GT}(T₀)] (4b)

4. Generator according to any one of claims 1 to 3, characterized in that it further comprises a multiplexing circuit (30) to which are applied the voltages (V_{G1}, V_{G2}, V_{G3}) and which is controlled by a control circuit (32) such as to select one of said voltages (V_{G1}, V_{G2}, V_{G3}).

5. Generator according to claim 4, characterized in that it further comprises a power amplifier (34) to which is applied the voltage selected by the control circuit (32).
